(19) United States
(12) Patent Application Publication
(10) Pub. No.: US 2018/0130246 A1
(43) Pub. Date: May 10, 2018

(54) Unkown

(71) Applicant: a.tron3d GmbH, Klagenfurt am Woerthersee (AT)

(72) Inventors: Juergen JESENKO, Riegersburg (AT); Andrej REICHMANN, Klagenfurt-Viktring (AT)

(21) Appl. No.: 15/783,345

(22) Filed: Oct. 13, 2017

(30) Foreign Application Priority Data
Oct. 13, 2016 (AT) GM 50210/2016

(51) Int. Cl. G06T 15/00; G06T 17/00; G06T 7/50

(52) U.S. Cl. CPC G06T 15/005; G06T 7/50; G06T 17/005

(57) ABSTRACT

Method for detection and optimization of a three-dimensional surface geometry, which is stored in a voxel-grid-based notation, in which during a first instant of detection, a clone of at least one part of the surface geometry is generated, the clone of the surface geometry being processed independently of the surface geometry, and the processed clone of the surface geometry and the surface geometry being brought together again at a second instant during the detection.

The invention relates to a method for detection and optimization of three-dimensional surface geometries, which are stored in a voxel-grid-based notation.

Nowadays, the surface geometry of objects is detected in many technical domains. Various three-dimensional methods of surface detection are used from quality assurance, via archival tasks, to imaging methods in medicine. Here, the quality and applicability of the detected geometry are determined essentially by two fundamental elements.

First of all, depth information is collected. This usually comprises a form of wave being sent onto the object to be detected, its being reflected by the object and its then being acquired by a sensor. In optical methods, it is usually light, and, for example, CCD chips can be used as sensors. With the sensor data, relief structures, in particular in the form of depth images, are then computed from the respective perspectives perspective of the sensor. This part of the detection of the surface geometry depends mainly on the physical components, with which the surface is being detected, such as, for example, the accuracy or resolution of sensors, the precision of lenses, and the like.

The computational steps in joining the individual reliefs together to form a common three-dimensional model are the second important component in the detection of three-dimensional surface geometries. An important part of this second decisive component is the notation that is chosen for the common 3D context.

Different notations can be useful for different tasks in this case. If the picture is to be able to be displayed, for example, as easily as possible and is no longer to be changed after detection, a polygonal notation such as STL is suitable. Here, the surface is notated as a network of triangles, each triangle being defined via the coordinates of its three corner points and its surface normal. Such notations that cannot be changed or can only be changed with great difficulty are especially suited, for example, to conservator scanning of works of art, such as, for example, antique statues.

Voxel-grid-based notations such as, for example, the SDF (Signed Distance Function) and the TSDF (Truncated Signed Distance Function) contrast with conventional notations as a polygon network. For the sake of simplicity, only the TSDF is explained below; the properties named for them can, however, be easily transferred by one skilled in the art to other voxel-grid-based notations, such as, for example, the SDF.

The Truncated Signed Distance Function (TSDF) indicates at one position within a defined three-dimensional grid (the voxel grid) the distance to the nearest surface. Here, the voxel grid is conventionally subdivided orthogonally and equidistantly into grid points (voxels). The sign of the function value or distance value provides information about whether this point is located outside or inside the surface. The actual surface is implicitly given and is located at the sites at which the function assumes the value of zero. For exact determination of the surface, it is enough if only the distance values near the surface are exactly known. If the function exceeds a certain maximum distance, the value is truncated and is interpreted as “far away.” It is conventional to choose the distance of two grid points from one another for the maximum value.

Notations in which the voxel grid is not equidistant and/or orthogonal are likewise conceivable. Thus, for example, depending on the measurement method, a spherical grid can also be advantageous, in which the coordinates in degrees of length and width together with a distance to the center of the sphere are notated.

The TSDF has two decisive advantages. Thus, in a TSDF for each region of the surface or of the three-dimensional object (within the framework of its resolution), in addition to the geometry of the object, other information can also be stored within the TSDF. This information can be, for example, information on the material of the object. This notation is often used in computer games. Thus, for example, in the vicinity of a surface, the information “of water” or “of earth” can be indicated in order in this way to make the interaction with the vicinity more realistic. In medical/diagnostic imaging, information such as, for example, “fat,” “nerve tissue,” and the like can be stored accordingly. Another possible application of this additional information is, for example, possible in detected surfaces in which precision that is as high as possible is especially valued. Thus, based on the conditions in the detection of the surface geometry of the surface, voxels can be assigned a value—how probably the detected surface geometry corresponds to the real surface geometry of the object.

The second major advantage of a voxel-grid-based notation compared to a polygonal notation consists in that a voxel-grid-based notation is much easier to change and supplement. This underlies the essential difference between explicit and implicit notations. If a 3D surface is given in an explicit notation, such as a polygon network, for example an STL, the change of even only one point leads to the change of all polygons that are defined via this point with their surface normals. The computations necessary for this purpose are tedious and resource-intensive and can lead to corruption of the entire surface geometry. Bringing together two—even slightly—different polygon networks is theoretically possible, but requires that all points in the two polygon networks be assigned to one point that corresponds in each case in the other polygon network, so that their position can be averaged. Since this is not possible in applications with real detected surfaces, in changes of polygon networks in general, simply the regions that have changed are cut out and replaced by new surface regions.

In contrast, implicit surface notations are much easier to supplement since here any surface information that is being detected and/or notated stands first of all for itself.

In addition, for example, it is demonstrable for a TSDF that solely based on the notation, the quality of the notated or detected surface rises in a TSDF if more pictures of the surface are taken, which are notated within the same TSDF. One possibility that is not given in this form for polygon-based notations.

The object of the invention is to make available further improved applications for voxel-grid-based notations.

This object is achieved according to the invention by a method with the features of claim 1.

In the method according to the invention, during a first essentially arbitrary instant of detection, a clone of at least one part of the surface geometry is generated, the clone being processed or able to be processed independently of the surface geometry. The clone and the surface geometry are then joined together again at a second essentially arbitrary instant during the detection.

Both a certain region, for example a quadrant of the voxel grid, and also an amount of information, for example all information with a certain property, can be understood in this case as a part of the surface geometry.

Therefore, a snapshot of the surface geometry is generated that exists and can be processed starting from the instant of generation independently of the “actual” (live) surface geometry to which data are further added after cloning. This has two advantageous effects. On the one hand, the clone that has been produced in this way is static; it is therefore no longer changed by externally supplied data, which enables many computations that would not be possible during a running scan process. On the other hand, there is essentially no longer any time limit for the processing of the clone. In particular, in medical applications, such as, for example, imaging in the dental domain, a display of the detected surface in real time is of top priority for user friendliness, for which reason conventionally each computation step must be executed within a very narrow time limit in order to provide to the user the perception of a real-time display. Therefore, during the current detection of a surface geometry, many possible and in particular improving computations are not carried out on it.

The voxel grid in which the clone is notated need not necessarily have the same size as the voxel grid in which the surface geometry itself is notated. The size of the voxel grid in this case has no effect on the surface that has been entered into the voxel grid, similarly to how the size of a two-dimensional coordinate system has no effect on the values that have been entered into the coordinate system.

However, it has proven advantageous to notate the clone in a larger voxel grid than the (original) surface geometry, since when the clone is being processed, additional data can arise that under certain circumstances must be notated at new voxel coordinates, which are not covered by the existing voxel grid.

Regardless of a change in the size of the voxel grid, the position of the surface geometry or of the clone of the surface geometry within the voxel grid can also be changed. This includes both translational and also rotational movements. In this way, the use of the voxel grid can be optimized. Of course, in doing so, a corresponding transformation matrix (depending on the need, consisting of a translation vector and/or a rotation matrix) can be stored, in order to simplify later joining of the surface geometry and clone together.

One preferred method of detection is in this case the optical—in particular the stereometric—detection of the surface geometry. Stereometrically-detected surface geometries are especially advantageous here, since in the conventional stereometric methods, the distance of the surface to the stereo base of the recording sensors or camera is determined. After determining a rotation matrix and a translation vector (together translation matrix), these distances can be especially comfortably notated in a voxel grid, for example in a TSDF, since this notation is also based on distances in a certain line of sight.

According to another preferred execution of the method, the values in the surface geometry and in the clone are weighted. This means that a weight is assigned to each distance value, which weight reflects the probability with which the value is correct. Greatly simplified, it can be stated: if a surface is “seen” more frequently at one point, the weight increases; if a point in space is recognized as empty, the weight drops.

Preferably, information that is in addition to the surface information within the surface geometry is taken over in cloning. At the instant of generation of the clone, the clone and the surface geometry have therefore notated the same weights per voxel.

According to the invention, the clone is processed after generation. This processing can include, for example, the removal of artefacts that have originated by computational error or by false pictures. False pictures can arise, for example, in the dental domain when the tongue or inside of the cheek of the patient or even an instrument, such as, for example, a suction apparatus, end up in the visual field of the instrument for detecting the surface geometry and are erroneously photographed, although they do not belong to intraoral structures that are to be recorded.

Another possibility for processing the clone is the closing of gaps. Thus, for a region that still has gaps, the curvature of the surface could be determined and from it a possible shape of the surface could be approximated. Of course, in this case, the resulting artificial surfaces would have to be provided with a correspondingly low weight within the clone. If the weight is then taken over when the surface geometry and the clone are being brought together, it can be easily overwritten or corrected by “genuine” seen*distances (*see also U.S. Pat. No. 9,363,501 B).

Preferably, the weights in the surface geometry and in the clone are added when being brought together. If, during processing of the clone, one would like to ensure that certain weights in the notated surface geometry to which further detected data have been added in the meantime are weakened when being brought together, negative weights can also be chosen for these voxels within the clone.

Another possibility for the processing of the clone is to add to the voxels information that has to do neither with the weight of the voxels nor with the geometry of the surface.

For example, voxels could be provided with information about the composition of the material of the surface. In the dental domain, for example based on the curvature of the surface, a distinction could be made between the properties “tooth” and “gum.” Or possible preparation suggestions could be developed whose limits can then be displayed on the visualized surface.

Other preferred embodiments of the invention are the subject matter of the dependent claims.

One preferred embodiment of the invention is presented in detail below based on the drawing. Here:

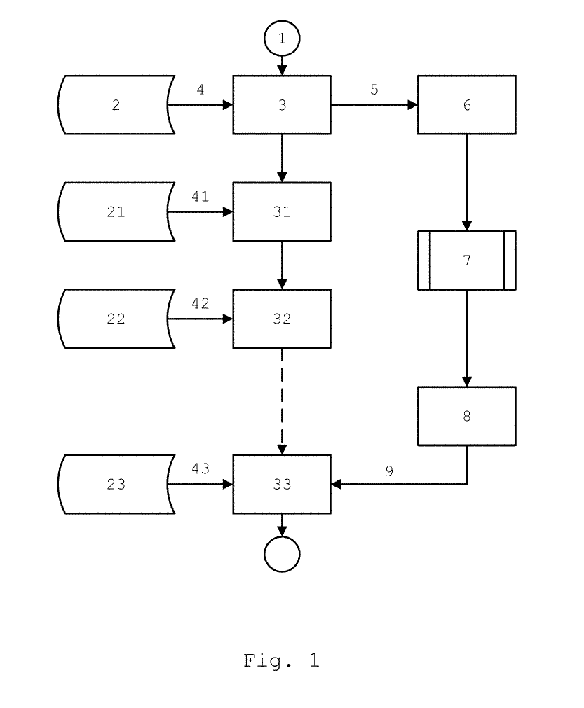

FIG. 1 shows a highly schematic sketch of one exemplary method according to the invention.

In the embodiment of a method for the detection and optimization of a three-dimensional surface geometry that is described below, a TSDF is used by way of example for the notation of the surface geometry. A clone of the surface geometry is accordingly a CTSDF in the described and illustrated example (see below).

The method according to the invention begins at a first instant 1 of detection. External data 2 from a detection process are added to a TSDF 3 (step 4). Then, a clone is created by the TSDF 3 (step 5), and thus a CTSDF 6 (Cloned Truncated Signed Distance Function) is generated. The CTSDF 6 is then processed (step 7). In the meantime, other external data 21, 22 are generated and added to the TSDF 31, 32 in steps 41, 42. Processing 7 of the CTSDF 6 yields a processed CTSDF 8.

After data 23 have been added to the TSDF for the n-th time (step 43) and thus an n-th TSDF 33 has been formed, the n-th TSDF 33 and the processed CTSDF 8 are brought together (step 9). In being brought together 9, the advantageous improvements on the processed CTSDF 8 are taken over into the n-th TSDF 33 and the n-th TSDF 33 itself is improved, although the scan process was not interrupted during this time.

### REFERENCE NUMBER LIST

1 first instant of detection
2 external data (from detection)
21 further external data
22 further external data
23 n-th external data
3 TSDF (original)
31 further TSDF
32 further TSDF
33 n-th TSDF
4 addition of data from the detection
41 further addition
42 further addition
43 n-th addition
5 clones
6 CTSDF
7 processing of the CTSDF
8 processed CTSDF
9 bringing the n-th TSDF and processed CTSDF together

1. Method for detection and optimization of a three-dimensional surface geometry, which is stored in a voxel-grid-based notation, wherein at a first point of time during detection, a clone of at least one part of the surface geometry is generated, wherein the clone of the surface geometry is processed independently of the surface geometry, and wherein the processed clone of the surface geometry and the surface geometry are merged (9) again at a second point in time during the detection.

2. Method according to claim 1, wherein the voxel grid in which the surface geometry is notated and the voxel grid in which the clone of the surface geometry is notated are of the same size.

3. Method according to claim 1, wherein the voxel grid in which the surface geometry is notated and the voxel grid in which the clone of the surface geometry is notated are of different size.

4. Method according to claim 3, wherein the voxel grid in which the clone is notated is larger than the voxel grid in which the surface geometry is notated.

5. Method according to claim 1, wherein detection is carried out optically, in particular stereometrically.

6. Method according to claim 1, wherein the surface geometry is notated in a TSDF (3).

7. Method according to claim 1, wherein the values of the surface geometry and of the clone (6) of the surface geometry are weighted.

8. Method according to claim 6, wherein in being merged (9), the weights of the surface geometry and of the clone of the surface geometry are likewise merged.

9. Method according to claim 1, wherein during the independent processing, attributes of the clone are generated and wherein the attributes of the clone are taken over into the surface geometry in being merged (9).

10. Method according to claim 1, wherein during the independent processing, attributes of the surface geometry are processed and wherein the processed attributes are taken over into the surface geometry in being merged (9).

11. Method according to claim 2, wherein detection is carried out optically, in particular stereometrically.

12. Method according to claim 3, wherein detection is carried out optically, in particular stereometrically.

13. Method according to claim 2, wherein the surface geometry is notated in a TSDF (3).

14. Method according to claim 3, wherein the surface geometry is notated in a TSDF (3).

15. Method according to claim 4, wherein the surface geometry is notated in a TSDF (3).

16. Method according to claim 2, wherein the values of the surface geometry and of the clone (6) of the surface geometry are weighted.

17. Method according to claim 3, wherein the values of the surface geometry and of the clone (6) of the surface geometry are weighted.

18. Method according to claim 4, wherein the values of the surface geometry and of the clone (6) of the surface geometry are weighted.

19. Method according to claim 5, wherein the values of the surface geometry and of the clone (6) of the surface geometry are weighted.

20. Method according to claim 2, wherein during the independent processing, attributes of the clone are generated and wherein the attributes of the clone are taken over into the surface geometry in being merged (9).
